(19) United States
(12) Patent Application Publication
(10) Pub. No.: US 2016/0076590 A1
(43) Pub. Date: Mar. 17, 2016

(54) BALL BEARING WITH SLANTED OR ANGLED FLAT RACEWAYS

(71) Applicant: Schaeffler Technologies AG & Co. KG, Herzogenaurach (DE)

(72) Inventor: William MORATZ, Gardiner, NY (US)

(73) Assignee: Schaeffler Technologies AG & Co. KG, Herzogenaurach (DE)

(21) Appl. No.: 14/950,789

(22) Filed: Nov. 24, 2015

(51) Int. Cl. F16C 33/58; F16C 19/16

(52) U.S. Cl. CPC F16C 33/585; F16C 19/163

(57) ABSTRACT

A rolling bearing assembly including a slanted or angled raceway is disclosed. The rolling bearing assembly includes a radially inner race on one of a supporting or supported element, and a radially outer race on the other of the supporting or supported element. A plurality of spherical rolling elements are arranged to roll on the radially inner race and the radially outer race. At least one of the radially inner race or the radially outer race is frusto-conical and has a flat profile in cross-section.

### FIELD OF INVENTION

The present invention relates to a bearing assembly and more particularly related to a low friction, axial load carrying bearing assembly.

### BACKGROUND

Rolling bearing assemblies are used in a wide range of applications. Known types of rolling bearing assemblies for low loads include low-speed slewing bearings or turn table bearings. Floating displacement bearings are used in high speed spindles, but these bearings are limited in terms of the types of applications in which they can be used. Spindle bearings with a spring preload can also be used in low load bearing applications. However, these spindle bearings are expensive and provide a higher degree of precision than is typically not required for low load applications. Another type of known bearing includes tapered roller bearings, but tapered roller bearings are expensive to produce and can cause undesirable friction.

It would be desirable to provide an alternative bearing configuration than a spindle or floating bearing that is inexpensive and minimizes friction for low load, low speed applications.

### SUMMARY

An inexpensive bearing assembly is provided for a low load, low speed bearing application. The rolling bearing assembly includes a radially inner race on one of a supporting or supported element, and a radially outer race on the other of the supporting or supported element. A plurality of spherical rolling elements are arranged to roll on the radially inner race and the radially outer race. At least one of the radially inner race or the radially outer race is frusto-conical and has a flat profile in cross-section.

A rolling bearing arrangement including first and second bearing assemblies are provided. The first bearing assembly includes a first radially inner race on one of a supporting or supported element, and a first radially outer race on the other of the supporting or supported element. A first plurality of spherical rolling elements are arranged to roll on the first radially inner race and the first radially outer race. At least one of the first radially inner race or the first radially outer race is frusto-conical and has a flat profile in cross-section. The second bearing assembly preferably includes a second radially inner race, a second radially outer race, and a second plurality of spherical rolling elements are arranged to roll on the second radially inner race and the second radially outer race.

### BRIEF DESCRIPTION OF THE DRAWINGS

The foregoing Summary and the following detailed description will be better understood when read in conjunction with the appended drawings, which illustrate a preferred embodiment of the invention. In the drawings:

FIG. 1 is a cross-sectional view of a first embodiment of a rolling bearing assembly.

FIG. 2 is a cross-sectional view of a second embodiment of a rolling bearing assembly.

FIG. 3 is a cross-sectional view of a third embodiment of a rolling bearing assembly.

FIG. 4 is a cross-sectional view of a fourth embodiment of a rolling bearing assembly.

### DETAILED DESCRIPTION OF THE PREFERRED EMBODIMENTS

Certain terminology is used in the following description for convenience only and is not limiting. The words “front,” “rear,” “upper,” and “lower” designate directions in the drawings to which reference is made. The words “inwardly” and “outwardly” refer to directions toward and away from the parts referenced in the drawings. “Axially” refers to a direction along the axis of a shaft or rotating part. A reference to a list of items that are cited as “at least one of a, b, or c” (where a, b, and c represent the items being listed) means any single one of the items a, b, or c, or combinations thereof. The terminology includes the words specifically noted above, derivatives thereof and words of similar import.

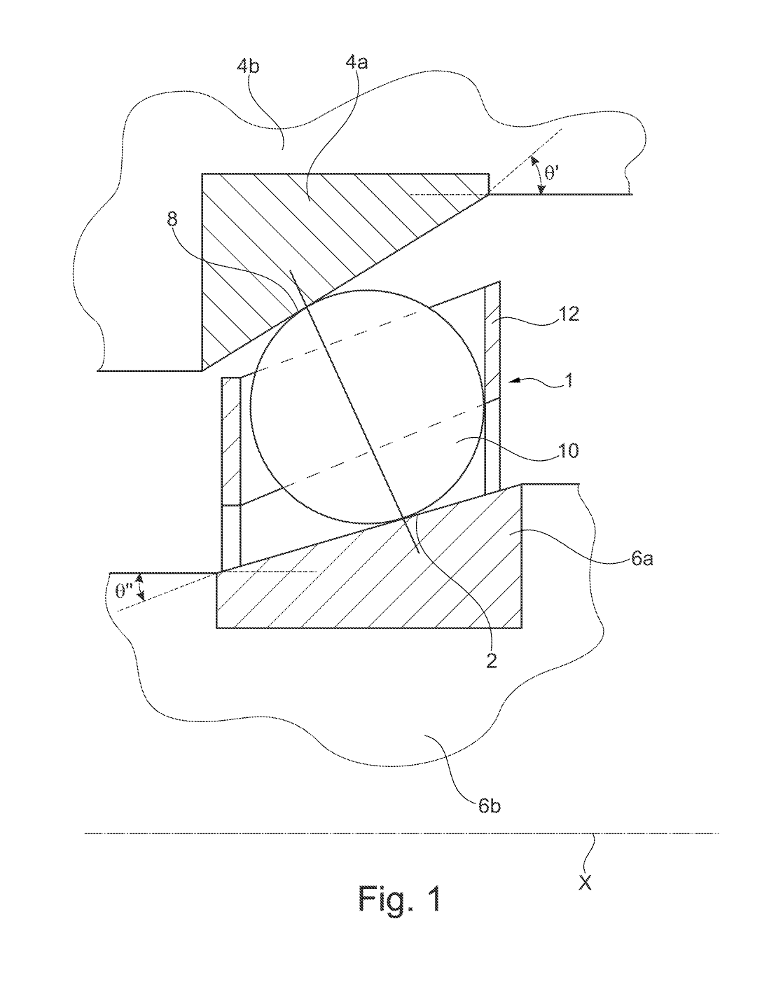

As shown in FIG. 1, a first embodiment of a rolling bearing assembly 1 includes a radially inner race 2 on one of a supporting element 4 or supported element 6. As shown in FIG. 1, the supported element 6 comprises a shaft washer 6a supported on a shaft 6b. A radially outer race 8 is defined on the other of the supporting element 4 or supported element 6. As shown in FIG. 1, the supporting elements 4 comprises a housing washer 4a on a housing 4b. One of ordinary skill in the will recognize from the present disclosure that the radially inner race 2 and the radially outer race 8 can be arranged on any of the components of the rolling bearing assembly 1, including directly on the shaft 6b and/or housing 4b. The bearing washer 4a and the shaft washer 6a are preferably made of a bearing grade steel. These can be installed on or molded with the housing 4b or the shaft 6b.

A plurality of spherical rolling elements 10 are arranged to roll on the radially inner race 2 and the radially outer race 8. At least one of the radially inner race 2 or the radially outer race 8 is frusto-conical and has a flat (i.e. linear) profile in cross-section. As shown in FIG. 1, both of the radially inner race 2 and the radially outer race 8 are frusto-conical and have flat cross-sectional profiles. One of ordinary skill in the art will recognize from the present disclosure that the profile of the races 2, 8 can be varied depending on a particular application. The races 2, 8 of the rolling bearing assembly 1 provide a point contact between each of the rolling elements 10 and the supporting element 4 and supported element 6, which reduces friction and improves efficiency of the bearing. As shown in FIG. 1, a cage 12 retains the plurality of spherical rolling elements 10 preferably equally spaced apart from one another.

As shown in FIG. 1, the radially outer race 8 is arranged at a first angle θ′ with respect to a rotational axis X of the rolling bearing assembly 1. The radially inner race 2 is arranged at a second angle θ″ with respect to the rotational axis X of the rolling bearing assembly 1. As shown in FIG. 1, the first angle θ′ of the radially outer race 8 is greater than the second angle θ″ of the radially inner race 2. One of ordinary skill in the art will recognize from the present disclosure that these angles can be varied depending on the application.

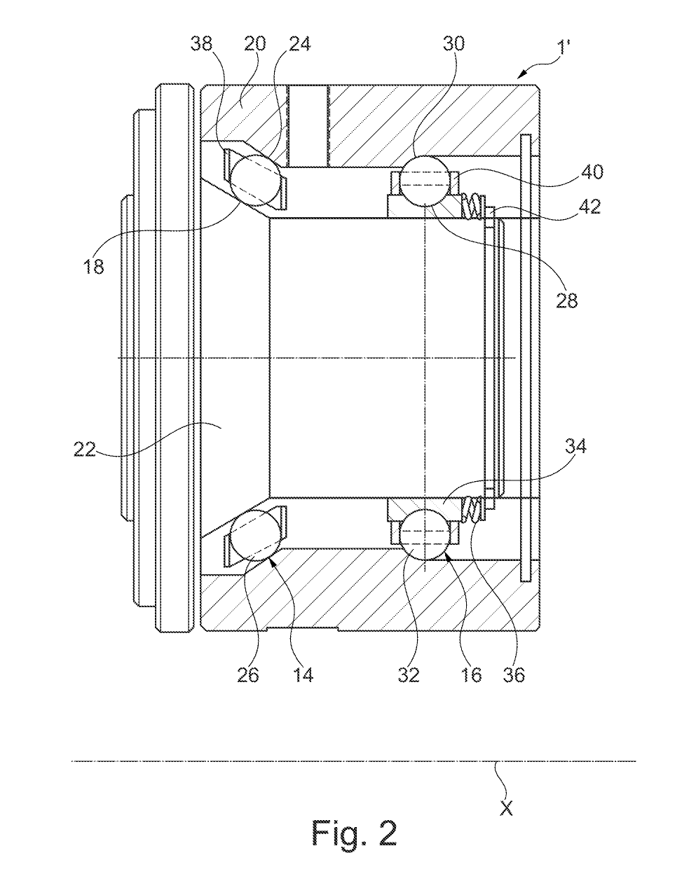

In a second embodiment of a rolling bearing arrangement 1′ shown in FIG. 2, a first bearing assembly 14 and a second bearing assembly 16 are provided. The first bearing assembly 14 includes a first radially inner race 18 on one of a supporting element 20 or a supported element 22, and a first radially outer race 24 on the other of the supporting element 20 or the supported element 22. As shown in FIG. 2, the supported element 22 is preferably a shaft and the supporting element 20 is preferably a housing. A first plurality of spherical rolling elements 26 are arranged to roll on the first radially inner race 18 and the first radially outer race 24. At least one of the first radially inner race 18 or the first radially outer race 24 is frusto-conical and has a flat (i.e. linear) profile in cross-section. As shown in FIG. 2, the first radially inner race 18 and the first radially outer race 24 are each frusto-conical and each have a flat profile in cross-section.

A second bearing assembly 16 is provided and preferably includes a second radially inner race 28 and a second radially outer race 30. A second plurality of spherical rolling elements 32 are arranged to roll on the second radially inner race 28 and the second radially outer race 30. As shown in FIG. 2, the second radially inner race 28 is defined on a radially inner bearing ring 34 supported on the supported element 22. The second radially outer race 30 is preferably defined directly on the supporting element 20. In this arrangement, the second bearing assembly 16 acts as a radial guide between the supporting and supported elements 20, 22.

As shown in FIG. 2, a spring 36 is preferably arranged between a snap ring 42 on the shaft 22 and the radially inner bearing ring 34. This can act to pre-load the shaft 22 in an axial direction so that the first radially inner race 18 is pressed toward the first radially outer race 24. As shown in FIG. 2, the second radially inner race 28 and the second radially outer race 30 each have a grooved profile. One of ordinary skill in the art will recognize from the present disclosure that either the second radially inner race 28 or the second radially outer race 30 can include other profiles besides grooved profiles. A first cage 38 preferably retains the first plurality of spherical rolling elements 26, and a second cage 40 preferably retains the second plurality of spherical rolling elements 32. One of ordinary skill in the art will recognize from the present disclosure that the first bearing assembly 14 and/or the second bearing assembly 16 could omit a cage. Additionally, other types of radial bearings could be used for the second bearing assembly.

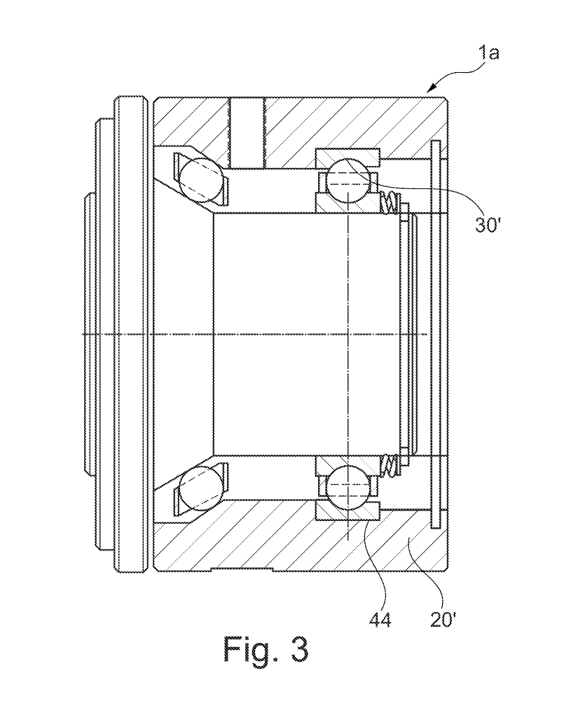

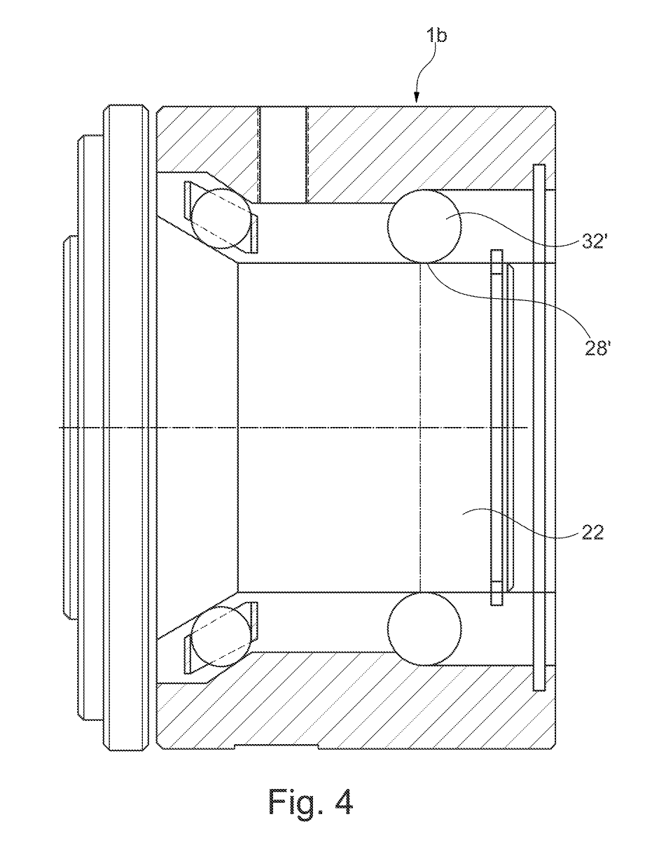

A third embodiment of a rolling bearing assembly 1a is shown in FIG. 3 and a fourth embodiment of a rolling bearing assembly 1b is shown in FIG. 4. The unlabeled elements in FIGS. 3 and 4 are identical the corresponding elements in FIG. 2. In the third embodiment shown in FIG. 3, the second radially outer race 30′ is defined on a radially outer bearing ring 44, and the radially outer bearing ring 44 is arranged on the supporting element 20′. Here, the supporting element 20′ is preferably molded around the outer bearing ring 44. In the fourth embodiment shown in FIG. 4, the second radially inner race 28′ is defined on the supported element 22. The rolling elements 32′ are shown with a larger diameter in FIG. 4 than the rolling elements 32 of FIG. 2, however one of ordinary skill in the art would recognize from the present disclosure that a variety of rolling elements with different sized diameters could be used depending on the particular application.

Having thus described the present invention in detail, it is to be appreciated and will be apparent to those skilled in the art that many physical changes, only a few of which are exemplified in the detailed description of the invention, could be made without altering the inventive concepts and principles embodied therein. It is also to be appreciated that numerous embodiments incorporating only part of the preferred embodiment are possible which do not alter, with respect to those parts, the inventive concepts and principles embodied therein. The present embodiment and optional configurations are therefore to be considered in all respects as exemplary and/or illustrative and not restrictive, the scope of the invention being indicated by the appended claims rather than by the foregoing description, and all alternate embodiments and changes to this embodiment which come within the meaning and range of equivalency of said claims are therefore to be embraced therein.

What is claimed is:

1. A rolling bearing assembly:
a radially inner race on one of a supporting or supported element;
a radially outer race on the other of the supporting or supported element; and
a plurality of spherical rolling elements arranged to roll on the radially inner race and the radially outer race, at least one of the radially inner race or the radially outer race is frusto-conical having a flat profile in cross-section.

2. The rolling bearing assembly of claim 1, wherein the supported element is a shaft, and the radially inner race is located on the shaft.

3. The rolling bearing assembly of claim 1, wherein the supporting element is a housing, and the radially outer race is located on the housing.

4. The rolling bearing assembly of claim 1, wherein a cage retains the plurality of spherical rolling elements.

5. The rolling bearing assembly of claim 1, wherein the radially inner race and the radially outer race are each frusto-conical having a flat profile in cross-section.

6. The rolling bearing assembly of claim 1, wherein an angle of the radially inner race is different than an angle of the radially outer race.

7. A rolling bearing arrangement:
a first bearing assembly including:
a first radially inner race on one of a supporting or supported element;
a first radially outer race on the other of the supporting or supported element; and
a first plurality of spherical rolling elements arranged to roll on the first radially inner race and the first radially outer race, at least one of the first radially inner race or the first radially outer race is frusto-conical having a flat profile in cross-section;
a second bearing assembly including:
a second radially inner race;
a second radially outer race; and
a second plurality of spherical rolling elements arranged to roll on the second radially inner race and the second radially outer race, at least one of the second radially inner race or the second radically outer race is formed on the supporting or supported element.

8. The rolling bearing arrangement of claim 7, wherein the second radially inner race is defined on a radially inner bearing ring supported on the supported element.

9. The rolling bearing arrangement of claim 8, wherein the radially inner bearing ring is biased by a spring.

10. The rolling bearing arrangement of claim 7, wherein the second radially inner race is defined on the supported element.

11. The rolling bearing arrangement of claim 7, wherein the second radially outer race is defined on the supporting element.

12. The rolling bearing arrangement of claim 7, wherein the second radially outer race is defined on a radially outer bearing ring.

13. The rolling bearing arrangement of claim 7, wherein the second radially inner race has a grooved profile.

14. The rolling bearing arrangement of claim 7, wherein the second radially outer race has a grooved profile.

15. The rolling bearing arrangement of claim 7, wherein the first radially inner race and the first radially outer race are each frusto-conical having a flat profile in cross-section.

16. The rolling bearing arrangement of claim 7, wherein a first cage retains the first plurality of spherical rolling elements, and a second cage retains the second plurality of spherical rolling elements.
